(19) United States
(12) Patent Application Publication
(10) Pub. No.: US 2025/0123094 A1
(43) Pub. Date: Apr. 17, 2025

(54) SYSTEM AND METHOD FOR INTERFEROMETRIC MEASUREMENT ALIGNMENT

(71) Applicant: ARIZONA OPTICAL METROLOGY LLC, TUCSON, AZ (US)

(72) Inventors: James Howard Burge, Tucson, AZ (US); Shelby D. Ament, Tucson, AZ (US); Logan Rodriguez Graves, Tucson, AZ (US); Edward Anthony LaVilla, New Haven, CT (US); Cormic Kevin Merle, Rochester, NY (US); Tyler G. Steele, Tucson, AZ (US)

(21) Appl. No.: 18/918,002

(22) Filed: Oct. 16, 2024

Related U.S. Application Data
(60) Provisional application No. 63/590,782, filed on Oct. 16, 2023.

(51) Int. Cl. G01B 9/02055; G01B 9/027

(52) U.S. Cl. CPC G01B 9/02063; G01B 9/027

(57) ABSTRACT

A system having a fixture with a unit under test (UUT) to be measured and at least one alignment target providing a reflective surface with curvature, and at least one alignment hologram oriented at a position of a measurement computer generated hologram (CGH). The alignment hologram being characterized by forming a wavefront that matches one of a point focus normal at a point upon, or a line focus along a segment along, the curvature of the reflective surface of the alignment target, when the UUT is at a target position aligned for interferometric measurement using the CGH. An interferometer or wavefront sensor detects when the wavefront from each of the one or more alignment holograms are aligned along the reflective surface. The alignment target and UUT are movable together with respect to the alignment hologram until alignment of the wavefront of the alignment hologram upon the alignment target is detected.

This application claims priority to U.S. Provisional Patent Application No. 63/590,782, filed Oct. 16, 2023, which is incorporated herein by reference.

### FIELD OF THE INVENTION

The present invention relates to a system and method for interferometric measurement alignment, and in particular to a system and method for interferometric measurement alignment having one or more alignment holograms disposed along with a measurement computer-generated hologram (CGH), and an alignment target having a curved reflective surface which when disposed at a target position for the measurement CGH enables interferometric measuring of the spatial profile of a surface of an object, called herein unit under test (UUT), disposed at the target position with the alignment target. Misalignment of a point or line focus wavefront formed by each alignment hologram upon the curved reflective surface is detectable in interferograms of the interferometer, and correctable by moving the alignment target until the interferogram indicates the point or line focus is aligned upon the curved reflective surface of the alignment target such that UUT is at the target position with respect to the measurement CGH for interferometric measurement of the spatial profile of the UUT.

### BACKGROUND OF THE INVENTION

Laser interferometers are used to enable accurate measurement of the spatial profile of an aspheric surface of a UUT. One way to achieve this is for an object beam optical wavefront from a laser interferometer to travel through a measurement computer-generated hologram (CGH) which transforms the object beam optical wavefront to match a desired spatial profile. The measurement CGH represents a diffractive element with curved lines written or etched on a glass substrate, and are available from Arizona Optical Metrology LLC of Tucson, Arizona. The returned beam reflected by the UUT surface travels back through the measurement CGH and is combined in the interferometer with a reference beam optical wavefront to generate interferograms utilized to determine the departure of the UUT surface from the desired spatial profile, as typical in interferometric measuring of a UUT's surface profile or shape. It is important that the UUT be positioned precisely with the measurement CGH for the object beam's wavefront propagation to be nulled to the desired spatial profile at the UUT, otherwise the measurement will be inaccurate as the shape of the propagating wavefront will not match the desired spatial profile.

Currently prior to measuring the UUT, a calibration process typically utilizes a corner-cube retroflector, two flat mirrors at right angles to one another, adjacent to the UUT in a fixture, and an alignment hologram is provided along the same substrate as the measurement CGH that transforms the object beam's optical wavefront from the interferometer into a line image that the flat reflective surfaces of the retroreflector's mirrors will generate a null interferogram with no fringes if the retroflector is at the correct spatial position with respect to the measurement CGH for testing the UUT. If the corner-cube retroflector reflects back an interferogram having fringes, the UUT is misaligned with the measurement CGH, and then the fixture is repositioned to move the reflector until no fringes are seen. Preferably, two alignment holograms are used for generating horizontal and vertical lines. For more information on this calibration process, see U.S. Pat. No. 11,774,236, issued Oct. 3, 2023, or PCT Published Application No. WO2022/170160, published Aug. 11, 2022. This calibration process works well when the CGH and UUT are at relatively large distances from each other, such as greater than 10 inches to several feet. However, as corner-cube retroflector mirrors useful for calibration are very precisely flat and aligned, they are expensive, thus it would be desirable to spatially align a measurement CGH to a UUT for interferometric measurement using a different and lower cost reflector as an alignment target, and moreover, can facilitate alignment over much shorter distances.

### SUMMARY OF THE INVENTION

It is an object of the present invention to provide a system and method for interferometric measurement alignment utilizing one or more alignment holograms and at least one alignment target having a curved reflective surface.

It is another object of the present invention to provide a system and method for interferometric measurement alignment using an alignment target having a curved reflective surface for alignment of a measurement CGH to an object providing a unit under test (UUT) for interferometric measurement of the spatial profile or shape of the UUT surface.

It is a further object of the present invention to provide a system and method for aligning a UUT for interferometric measurement utilizing one or more alignment holograms providing wavefronts forming a point or line focus upon the curvature of the reflective surface of an alignment target, which further enable the measurement CGH to be close to the UUT, such as at or between 0.1 to 10 inches.

Briefly described, the present invention embodies a system having at least one alignment target having a reflective surface with curvature representing a target surface, one or more alignment holograms disposed at a first position, and an interferometer outputting an object beam, receiving a return beam, and outputting on a display an interferogram representative of any phase interference of the return beam with a reference beam (representing a reflected version of the object beam). Each of the one or more alignment holograms transforms at least a portion of an object beam from the interferometer into an alignment wavefront which will form a point or line focus along the curvature of the target surface of the alignment target when the alignment target is disposed at a target position with respect to the first position. The alignment target is movable to correct any misplacement of the alignment target from the target position until the interferogram indicates the alignment target is disposed at the target position by the point focus or line focus being formed along the curvature of the target surface.

The one or more alignment holograms are provided along a substrate at the first position with a measurement computer-generated hologram (CGH) which provides a measurement wavefront representative of a desired target spatial profile of the surface of a UUT mountable on a fixture with the alignment target, in which movement of the fixture enables the alignment target and the UUT to be movable together until at the target position. In operation, with the fixture at the target position, the measurement CGH transforms the object beam of the interferometer into the measurement wavefront which falls upon the UUT, and the return beam reflected by the UUT surface travels, via the measurement CGH, to the interferometer, such that the interferometer outputs the interferogram on its display representative of any departure of the surface of the UUT from the desired target spatial profile, thereby enabling interferometric measuring of the UUT surface.

A plurality of different alignment targets may be provided each having a reflective surface with same or different curvature in accordance with a different one of the alignment holograms. Further, a plurality of the alignment holograms may be provided along the substrate at the first position each transforming at least a portion of the object beam into an alignment wavefront which will form a different point or line focus along a curvature at a same one or different alignment targets when the alignment targets are disposed at the target position.

The invention further provides a system for aligning a measurement CGH with a UUT to enable spatial profile measurement of the surface of the UUT. Such system having a fixture upon which at least one alignment target, having a reflective surface with curvature, and the UUT to be measured, one or more alignment holograms, oriented at a position of the measurement CGH, each characterized by forming a wavefront that matches one of a point focus with a central ray normal to a point along the curvature of the reflective surface, or a line focus along a segment of the curvature of the reflective surface when the UUT is at a position aligned for interferometric measurement via the measurement CGH. The system preferably has an interferometer or wavefront sensor to detect when the wavefront from each of the one or more alignment holograms are aligned along the reflective surface. When an interferometer is utilized, it is preferably the same interferometer for enabling interferometric measurement of the UUT. The fixture being movable mounted with respect to a platform to reposition the alignment target and UUT together with respect to the one or more alignment holograms until alignment of the wavefront of each of the one or more alignment holograms upon the alignment target is detected utilizing the interferometer or wavefront sensor.

In the preferred embodiment, the system has an interferometer outputting an object beam, receiving a return beam, and outputting on a display an interferogram representative of any phase interference of the return beam with a reference beam, and the one or more alignment holograms disposed on a substrate associated with the measurement CGH, and the curved reflective surface of the alignment target receiving and reflecting the transformed portion of the object beam from each of the one or more alignment holograms in the return beam, which travels via the one or more alignment holograms, to the interferometer. Each of the one or more alignment holograms transforms at least a portion of the object beam into having an alignment wavefront that will form the point focus or a line focus upon the curved reflective surface when at a target position aligned with the substrate. Any misalignment of the alignment target from the target position by the point or line focus being mispositioned upon curved reflective surface is detectable in the interferogram and correctable by moving the alignment target relative to the substrate toward the target position until the interferogram indicates alignment of the point focus or line focus upon the curved reflective surface of the alignment target. At such target position, the UUT, disposed adjacent to the alignment target, receives a measurement wavefront provided by the measurement CGH that represents a target spatial profile for such UUT, and the UUT surface reflects the measurement wavefront in the return beam to the interferometer enabling the UUT surface to be interferometrically measured.

The one or more alignment holograms each represent a diffractive element etched or written lines formed at different locations along a substrate, such as a glass plate, along with the measurement CGH. The substrate extends along x and y axes orthogonal dimensions, and at a distance along the z axis, orthogonal to the x and y axes, from a fixture having the alignment target and the UUT. The curved reflective surface of the alignment target and surface(s) of the UUT to be measured are spatially aligned with each other in the fixture and face the substrate having the one or more alignment holograms and the measurement CGH. Misalignment detectable in the interferogram is in one or more of difference from the target position of the alignment target along one or more of the x (horizontal), y (vertical), or z (distance) axes, or tilt along one of planes extending along one or more of the x and y axes, x and z axes, or, y and z axes. Less preferably, the substrate is an assembly of one or more of the alignment holograms which are each formed on another substate and then fixed in position upon the surface or an opening through a substrate having the measurement CGH, such that alignment hologram(s) and measurement CGH lie coplanar, or parallel along x y plane, to each other. An alignment hologram providing a point focus may further include a central portion providing a point focus an outer portion providing an annular focus about the periphery of the central portion. When multiple alignment holograms are provided on a substrate, they may form same or different wavefronts enabling alignment on curved reflective surface of the alignment target as desired for the particular measurement CGH.

The alignment target may be a spherical mirror ball providing the curved reflective surface, but the alignment target may provide any curved convex or concave symmetric or aspheric reflective surface, or other curvature, such as freeform, so long as the alignment hologram(s) each form a wavefront that matches one of a point focus normal at a point along the curvature of such reflective surface, or a line focus along a curved segment of the curved reflective surface, when the UUT to be measured is at a position aligned for interferometric measurement via the measurement CGH. The fixture, upon which the alignment target and UUT to be measured are mounted, is movable in a plurality of dimensions along a platform or stand such that the UUT and alignment target move together. A plurality of controls along the platform each provide different degrees of freedom of motion to the fixture relative to the platform to correct for any misalignment of the alignment target from the target position, where such degrees of freedom are along dimensions of horizontal, vertical, and distance adjustment, as well as tilt.

For an alignment hologram forming a point focus, the interferogram will be null, and the entire shape of the aperture of the alignment hologram will be viewed, such as circular or rectangular, when aligned at a location along the curved reflective surface normal to the point focus. When such point focus is misaligned on the curved reflective surface of the alignment target, the interferogram detects such by the presence of feature indicative of misalignment, such as fringes, or a partial displacement or shift in the aperture of the alignment hologram in the return beam, in the interferogram. Fringes appear in interferograms since the point focus is misaligned along the curved reflective surface of the alignment target causing the phase of the return beam to the interferometer being offset with respect to the interferometer's reference beam. For example, the interferogram will have circular fringes if the point focus is misaligned in distance along the z axis from the reflective surface, or a displacement of the aperture of the return beam if the point focus is misaligned horizontally along the x axis, vertically along the y axis, and/or tilted if the point focus wavefront is not oriented normal to the reflective surface of the alignment target.

For an alignment hologram forming a line focus, the interferogram will have at least substantially parallel fringes (i.e., alternating black and white substantially parallel lines) when the alignment target is at the target position such that when the line focus is aligned along the curved reflective surface at which its arc shaped wavefront will form a line along a curved segment of the curved reflective surface. Misalignment of a line focus is detected in interferograms by linear fringes that are not generally parallel to each other. The fringes appear in interferograms since the line focus is misaligned the curved reflective surface of the alignment target causing the phase of the return beam to the interferometer being offset with respect to the interferometer's reference beam.

One or more of the alignment holograms may have a structure with a center and one or more optional opaque marking(s) or phase-shifting region(s) disposed about such center. The opaque marking(s) or phase-shifting regions are detectable in an interferogram with mirrored (180 degrees inverted) versions of the opaque marking(s) or phase-shifting region(s) reflected from the alignment target about the center. This may be used further for alignment to indicate when a fixture with the alignment target and the UUT is at the target position for the CGH associated with the alignment target. The opaque marking(s) may be formed by depositing light blocking material upon the surface of the alignment hologram, while phase shifting region(s) may be formed by a surface relief in the transparent material, such as glass, of the alignment hologram. In this manner, one or more opaque markings or phase-shifting regions disposed about the center of an alignment hologram forming a point focus provides mirrored ones of the one or more markings or regions symmetrically distributed about the center with the one or more markings or regions in an interferogram on the display of the interferometer or wavefront sensor, when such alignment hologram is aligned along the curved reflective surface of the alignment target. Further, an opaque marking or phase-shifting region disposed about the center of an alignment hologram forming a line focus provides a mirrored one of the marking or region symmetrically distributed about the center with the marking or region in a interferogram on the display of the interferometer or wavefront sensor, when such alignment hologram is aligned along the curved reflective surface of the alignment target.

One or more of the alignment holograms may also introduce a wavefront modulation in its phase function which exhibits a symmetry that cancels out upon reflection off of the aligned curved reflective surface of the alignment target. This cancellation of the wavefront modulation is due to the symmetry present in the reflection (180 degree rotation in the case of a point focus, mirror symmetry in the case of a line focus) when the alignment target is at the target position. If the alignment target is laterally misaligned, the lateral shift of the return beam relative to alignment hologram will produce a signature in the wavefront in the interferogram that indicates the misalignment present. By selection of wavefront modulation function, orthogonal (unique) wavefront signatures connected to specific misalignment degrees of freedom can be produced.

The present invention further embodies a method for aligning a UUT to enable spatial profile measurement of a surface of the UUT comprising steps of: providing a fixture having an alignment target with a reflective surface with curvature and the UUT to be measured; providing one or more alignment holograms, oriented at a position of a measurement CGH, each characterized by forming a wavefront that matches one of a point focus normal to a point along the curvature of the reflective surface, or a line focus along a segment of the curvature of the reflective surface, when the UUT is at a position aligned for measurement via the measurement CGH. The method further comprises using an interferometer or wavefront sensor to detect when the wavefront from each of the one or more alignment holograms are aligned along the reflective surface.

### BRIEF DESCRIPTION OF THE DRAWINGS

The foregoing and other objects, features and advantages of the invention will become more apparent from a reading of the following description in connection with the accompanying drawings in which:

FIG. 1A is a block diagram schematically illustrating the present invention for interferometric measurement alignment using an alignment target providing a curved reflective surface facing a substrate having a measurement CGH providing a spatial target profile of a UUT to be measured and one or more alignment holograms;

FIG. 1B is front view of a fixture in FIG. 1A having the UUT to be interferometric measured and the alignment target in which such fixture is movable along a plurality of dimensions with respect to a platform or stand;

FIG. 2 is a front view of a substrate of FIG. 1A showing an example orientation of alignment holograms and the measurement CGH;

FIG. 3 is a visualization of the output of two different alignment holograms of FIG. 2 in an example of a point focus and a line focus when aligned upon the alignment target of FIG. 1A in the case where such alignment holograms are illuminated with a visible laser beam;

FIG. 4A is a side view of one of the alignment holograms forming a point focus, where the alignment hologram is shown removed from the substrate of FIG. 1A;

FIG. 4B shows the alignment hologram of FIG. 4A forming a point focus aligned at a location of the reflective surface of the alignment target of FIG. 1A, where the alignment hologram and the alignment target are shown removed from the system of FIG. 1A;

FIG. 4C shows a null interferogram outputted on a display by the interferometer of FIG. 1A for the case of an aligned point focus of FIG. 4B;

FIG. 4D shows the alignment hologram of FIG. 4A forming a point focus misaligned along the reflective surface of the alignment target of FIG. 1A, where the alignment hologram and the alignment target are shown removed from the system of FIG. 1A;

FIG. 4E shows an interferogram outputted on a display by the interferometer of FIG. 1A for misaligned point focus of FIG. 4D in the case where the point focus is horizontally misaligned such that the return beam to the interferometer is partially displaced with respect to the interferometer's reference beam that it appears as a shift in the aperture or profile shape of the alignment hologram in the interferogram;

FIGS. 4F and 4G shows the alignment hologram of FIG. 4A forming a point focus distance misaligned along the reflective surface of the alignment target of FIG. 1A by being too close to or too far from, respectively, the alignment hologram from alignment, where the alignment hologram and alignment target are shown removed from the system of FIG. 1A;

FIG. 4H shows an interferogram outputted on a display by the interferometer of FIG. 1A for misaligned point focus of FIGS. 4F and 4G;

FIG. 5 is a side view of the substrate of FIG. 1A having an example of five alignment holograms forming point foci along the reflective surface of the alignment target of FIG. 1A, where the alignment hologram and the alignment target are shown removed from the system of FIG. 1A;

FIG. 6A is a side view of the substrate of FIG. 1A having an example of an alignment hologram having a central portion forming a point focus and an outer annular portion sending line rays normal to the reflective surface of the alignment target of FIG. 1A, where the alignment hologram and the alignment target are shown removed from the system of FIG. 1A and an upper portion of the alignment target is shown;

FIG. 6B shows a front view of the alignment hologram of FIG. 6A;

FIGS. 6C and 6D are interferograms outputted on a display by the interferometer of FIG. 1A when using the alignment hologram of FIGS. 6A and 6B in which FIG. 6C shows no fringes indicative of alignment, and FIG. 6D shows fringes indicative of lateral misalignment and partial displacement indicative of off-center misalignment, between the alignment target and the alignment hologram;

FIGS. 7A and 7B are side and top views, respectively, of one of the alignment holograms forming a line focus aligned along a portion of the reflective surface of the alignment target of FIG. 1A, where the alignment hologram and the alignment target are shown removed from the system of FIG. 1A;

FIGS. 8A, 8B, 8C, and 8D show a series of interferograms on a display of the interferometer of FIG. 1A, where FIG. 8A shows a first interferogram with a misaligned line focus, FIGS. 8B and 8C show examples of second and third interferograms as the fixture with the alignment target of FIG. 1A is moved closer to alignment, until FIG. 8D which shows a fourth interferogram with aligned line focus;

FIG. 9A is a broken schematic front view of one of the alignment holograms on the substrate of FIG. 1A providing a point focus showing a shadow pattern provided by the addition of two opaque linear markings along two orthogonal dimensions upon the structure of the alignment holograms;

FIG. 9B shows an interferogram outputted on a display by the interferometer of FIG. 1A for the case of the alignment hologram of FIG. 9A providing a point focus aligned along the reflective surface of the alignment target of FIG. 1A further indicated by an aligned cross-hair along two orthogonal dimensions of the two opaque linear markings with mirrored ones of such markings;

FIG. 9C shows an interferogram outputted on a display by the interferometer of FIG. 1A for the case of the alignment hologram of FIG. 9A providing a point focus misaligned along the reflective surface of the alignment target of FIG. 1A further indicated by a misaligned cross-hair along two orthogonal dimensions of the two opaque linear markings with mirrored ones of such markings;

FIG. 10A is front view of one of the alignment holograms on the substrate of FIG. 1A providing a line focus showing a shadow pattern provided by the addition of an opaque linear marking upon the structure of the alignment hologram;

FIGS. 10B and 10C shows two interferograms outputted on a display by the interferometer of FIG. 1A for the case of alignment hologram providing a line focus along the reflective surface of the alignment target of FIG. 1A with a single one opaque linear marking of FIG. 10A upon the structure of the alignment hologram, where FIG. 10B shows misalignment of the line focus along the reflective surface of the alignment target of FIG. 1A, and FIG. 10C shows alignment of the line focus along the reflective surface of the alignment target of FIG. 1A further indicated by a cross-hair along a single dimension of the opaque linear marking with a mirrored one of such marking;

FIG. 11A is a perspective view of one of the alignment holograms forming a point focus upon the reflective surface of the alignment target of FIG. 1A having a shadow pattern upon a circular area of the alignment hologram provided by multiple opaque linear markings upon the structure of the alignment hologram, where the alignment hologram and the alignment target are shown removed from the system of FIG. 1A;

FIG. 11B is a front view of the alignment hologram of FIG. 11A providing a point focus showing opaque linear markings at right angles to each other about the center of the structure of the alignment hologram along a circular area denoted in FIG. 11A;

FIG. 11C shows an interferogram outputted on a display by the interferometer of FIG. 1A for the case of alignment hologram of FIGS. 11A and 11B providing a point focus aligned along the reflective surface of the alignment target of FIG. 1A using opaque linear markings of FIG. 11B to provide cross-hairs in the interferogram;

FIG. 11D shows an interferogram outputted on a display by the interferometer of FIG. 1A for the case of alignment hologram of FIGS. 11A and 11B providing an example of a point focus when misaligned along the reflective surface of the alignment target of FIG. 1A by lacking aligned cross-hairs in addition to partially displacement;

FIGS. 12A, 12C, and 12E are side views of the substrate of FIG. 1A having an array of alignment holograms each forming point foci along the reflective surface of the alignment target of FIG. 1A, each alignment hologram having shadow pattern provide by opaque linear markings of FIG. 9A, where FIG. 12A shows alignment of point foci along the alignment target, and FIGS. 12C and 12E show two different conditions of misalignment of point foci along the alignment target, where the alignment hologram and the alignment target are shown removed from the system of FIG. 1A;

FIGS. 12B, 12D, and 12F shows interferograms outputted on a display by the interferometer of FIG. 1A for the case of point foci depicted in FIGS. 12A, 12C, and 12E, respectively;

FIGS. 13A, 13B, 13C, and 13D show interferograms outputted on a display by the interferometer of FIG. 1A for the case of the alignment hologram providing a line focus of FIGS. 7A and 7B with an orthogonal tilted wavefront;

FIG. 14A is a side view of substrate of FIG. 1A with two alignment holograms forming vertical line foci aligned along a different portion of the reflective surface of the alignment target of FIG. 1A, where the alignment holograms and the alignment target are shown removed from the system of FIG. 1A;

FIGS. 14B and 14C are same view as FIG. 14A illustrating the line foci of the alignment holograms where substrate is misaligned with respect to the alignment target by being positioned too close in distance to the substrate in FIG. 14B, and by being positioned too far in distance to the substrate in FIG. 14C;

FIGS. 14D, 14E, and 14F show two portions of an interferogram outputted on a display by the interferometer of FIG. 1A for the case of the two alignment holograms of FIGS. 14A, 14B, and 14C, respectively;

FIG. 15A is the same front view of the same fixture as FIG. 1B having the UUT to be interferometric measured for an embodiment having two alignment targets vertically aligned one above and the other below the UUT;

FIG. 15B is a back view of the substate of FIG. 1A in an example of two alignment holograms each providing a vertical line focus upon a different one of two alignment targets of FIG. 15A, in which the line foci are aligned vertically to each other when each are aligned along their respective alignment target;

FIG. 15C is the same view as FIG. 15B, except where the two alignment targets are clocked with respect to the substrate and thus misaligned;

FIG. 15D shows two portions of an interferogram outputted on a display by the interferometer of FIG. 1A for the case of FIG. 15C having fringes pointing in opposite directions to each other;

FIG. 16 is a broken side view of the fixture of FIG. 1A showing a first another embodiment of the alignment target;

FIG. 17 is a broken side view of the fixture of FIG. 1A showing a second another embodiment of the alignment target having a central alignment target with a reflective curved surface surrounded by a concentric specular reflective alignment target with a different curvature then that of the central alignment target, and illustrations of aligned and various misaligned conditions upon the alignment target of a wavefront from an alignment hologram on the substrate of FIG. 1A providing a point focus, or side view of a line focus;

FIG. 18A is a broken side view of the fixture of FIG. 1A showing a third another embodiment of the alignment target upon a diffuse reflective surface, and illustrations of aligned and various misaligned conditions upon the alignment target of a wavefront from an alignment hologram on the substrate of FIG. 1A providing a point focus, or side view of a line focus;

FIG. 18B is a top view of the alignment target of FIG. 18A; and

FIG. 19 is a broken side view of the fixture of FIG. 1A showing a fourth another embodiment of the alignment target having a curved reflective surface which gradually increases in curvature from an outer edge to center, and illustrations of aligned and various misaligned conditions upon the alignment target of a wavefront from an alignment hologram on the substrate of FIG. 1A providing a point focus, or side view of a line focus.

### DETAILED DESCRIPTION OF THE INVENTION

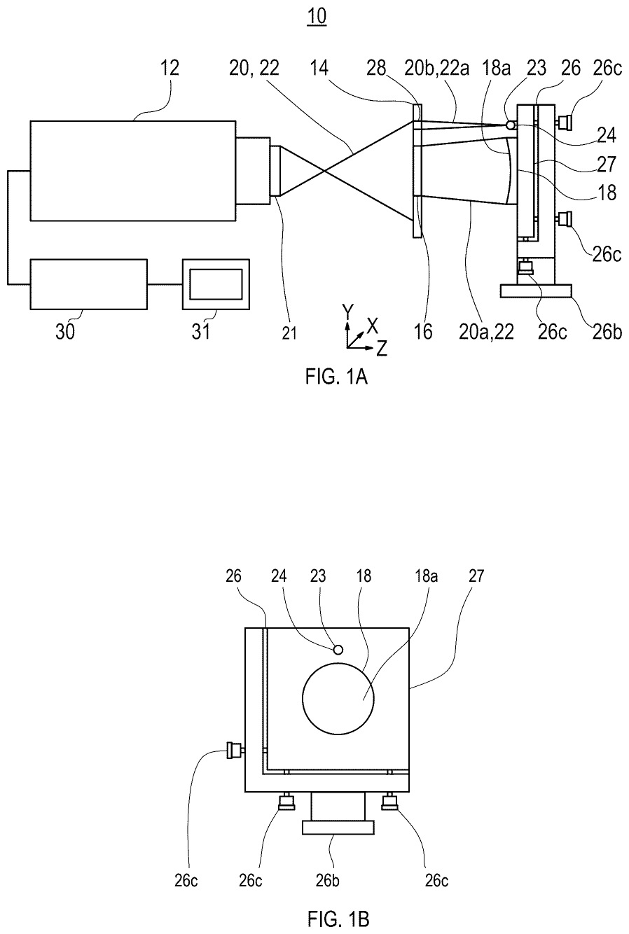

Referring to FIG. 1A, a block diagram of a system 10 of the present invention is shown having a laser interferometer 12 and a substrate (or plate) 14 with at least a measurement computer-generated hologram (CGH) 16 which allows the interferometer 12 to measure spatial profile of an aspheric curved surface 18a of an object or unit under test (UUT) 18 with high precision. An example UUT 18 is shown in FIG. 1A having a surface 18a facing CGH 16, but surface 18a may be a different surface than shown so long as it is not spherical or flat. The interferometer 12 operates in the manner of a typical phase-shift interferometer by directing an object (or input) beam 20 via collimating optics 21 to CGH 16 which transforms the optical wavefront of object beam 20 to provide a transformed object beam 20a matching a desired spatial profile of surface 18a of UUT 18, and receives a return beam 22 from UUT 18 that travels back through the CGH 16 and is combined in the interferometer 12 with a reference optical wavefront to generate an interferogram on a display 31 utilized to determine the departure of surface 18a from the desired spatial profile of the CGH 16, as typical in interferometric measuring of a UUT using CGHs as sold and manufactured by Arizona Optical Metrology of Tucson, Arizona. Interferometer 12 may be a Fizeau interferometer, and part of a computer system 30 programmed to operate in accordance with software in its memory to output interferograms on display 31 in a manner typical of interferometers.

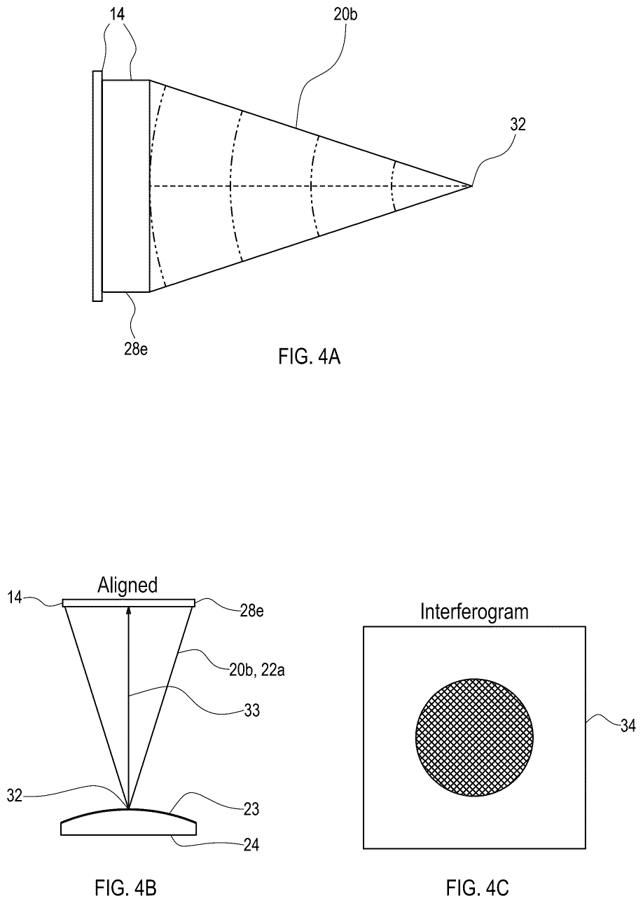

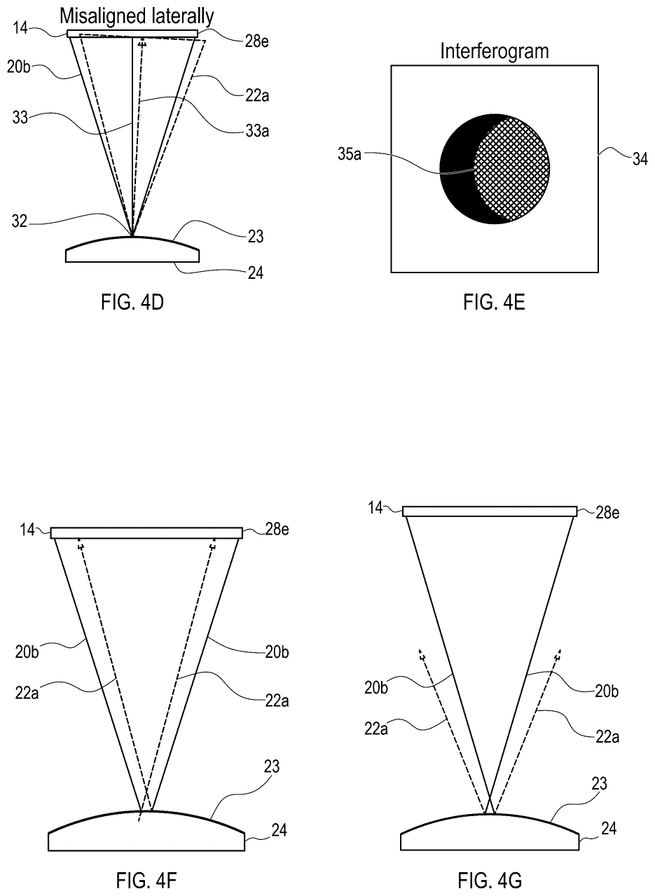

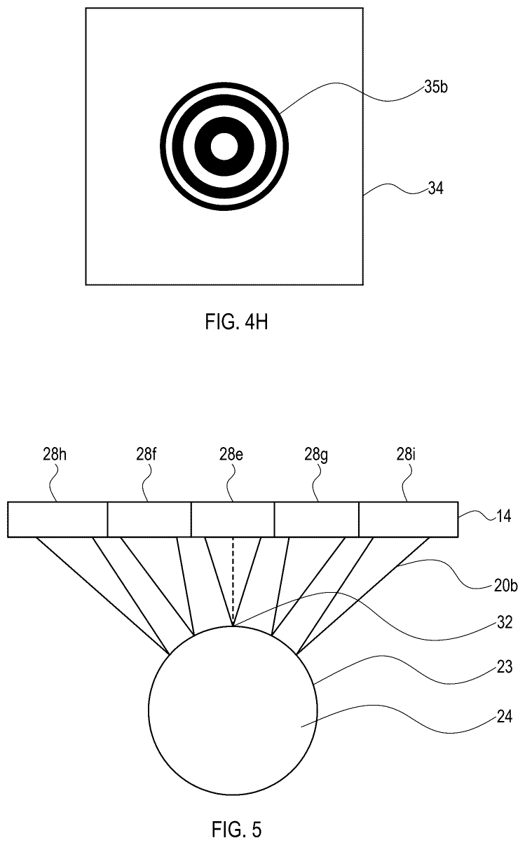

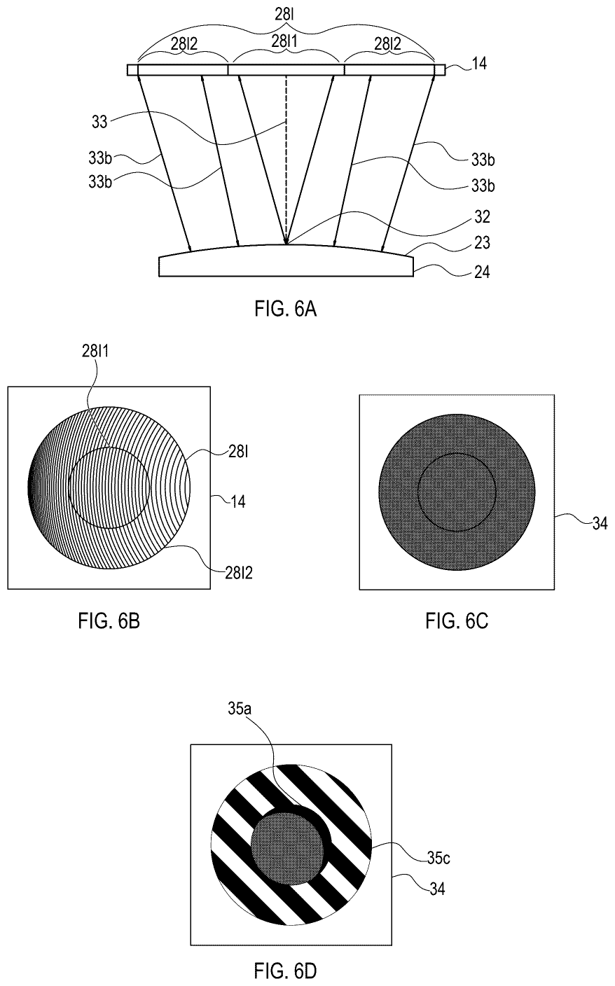

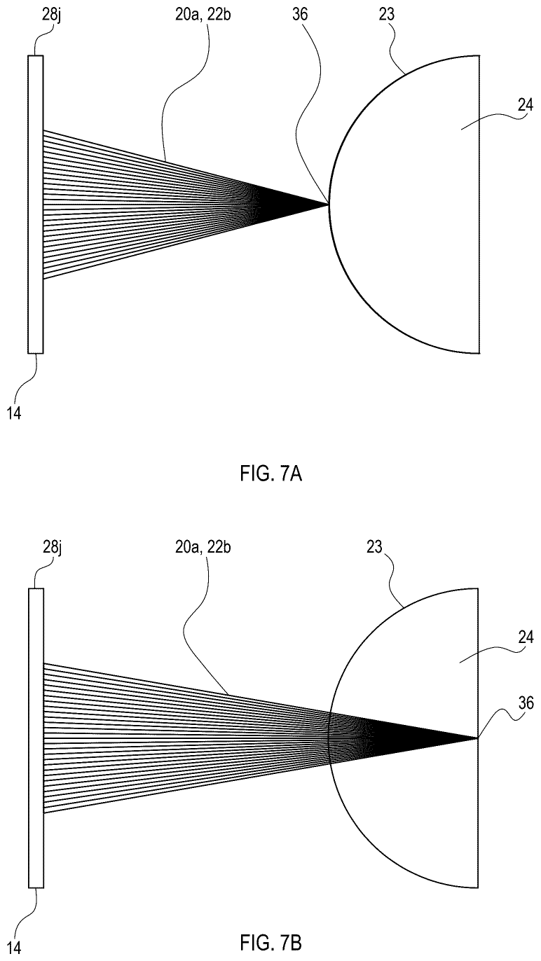

The improvement provided by the present invention is the incorporation in system 10 of a curved reflective surface 23 of an alignment target (reflector or reference element) 24, such as a spherical ball, extending from a fixture 27 mounted to be movable in a plurality of dimensions along a platform or stand 26, and one or more alignment holograms 28 being provided with CGH 16 along substrate 14 at a first position. Each of the one or more alignment holograms 28 represents a diffractive element that transforms a portion of object beam 20 incident thereto into an alignment wavefront 20b that will form either a point focus or a line focus, in accordance with the structure of its diffractive pattern, along curved reflective surface 23 when the alignment target 24 is disposed at a target position at a distance and orientation optimal for that particular CGH 16 at the first position for accurately measuring surface 18a of UUT 18, i.e., where the shape of the propagating wavefront of object beam 20a from CGH 16 is optimal for measuring surface 18a of UUT 18. Reflective surface 23 receives and reflects the transformed portion of the object beam from each of the alignment holograms 28 in return beam 22a, via alignment holograms 28, which combines with the return beam 22 to the interferometer 12. FIG. 3 shows a visualization of the point focus 29a and line focus 29b from different ones of alignment holograms 28 on a curved reflective surface 23 in response to a laser beam of a visual wavelength. Example of different alignment holograms 28 are described below forming point focus in the case of alignment hologram 28e (FIG. 4A), a line focus in the case of alignment hologram 28j (FIGS. 7A and 7B) along a desired dimension, or combination of point focus along a central portion and an outer portion providing an annular focus in the case of alignment hologram 28l (FIG. 6A). When multiple alignment holograms 28 are provided on substrate 14, they may form same or different wavefronts as desired for the particular CGH application.

Referring to FIGS. 1A and 1B, UUT 18 is mounted adjacent alignment target 24 along fixture 27 so that they move together with respect to platform 26, and fixture 27 maintains surface 18a of UUT 18 spatially aligned with reflective surface 23. Fixture 27 is movable with respect to platform 26 in one of a plurality of freedoms of motion relative to the platform's frame 26a fixed to a base 26b by three micrometers 26c. Substrate 14 extends along x and y axes orthogonal dimensions, and along a z axis orthogonal to the x and y axis, at a distance along the z axis from fixture 27. UUT 18 is preferably mounted by one or more clamps (not shown) that engages along the outer perimeter of the UUT and/or pins or screws that engage in to threaded holes if presents into the back of the UUT, but other mounting mechanism may be used for releasably retaining the UUT to fixture 27 for interferometric measuring of spatial profile or shape of its surface 18a.

While the distance of the target position for UUT 18 may be generally known for different ones of CGH 16, such as between 0.1 to 10 inches, the actual target position must be finely tuned to micrometer accuracy, depending on the desired resolution for interferometric measurement of UUT's surface 18a. Unlike the flat, non-curved prior art corner-cube retroflectors described earlier for alignment of a measurement CGH, alignment target 28 can be much less expensive since it can be provided by a spherical mirror ball mounted to fixture 27. Further, system 10 with alignment target 28 and their associated alignment holograms 28 facilitate alignment of the measurement CGH 16 over much shorter distances than prior art corner-cube retroflectors, enabling more compact system 10 enabling both alignment and interferometric CGH measuring than the prior art for measure spatial profiles.

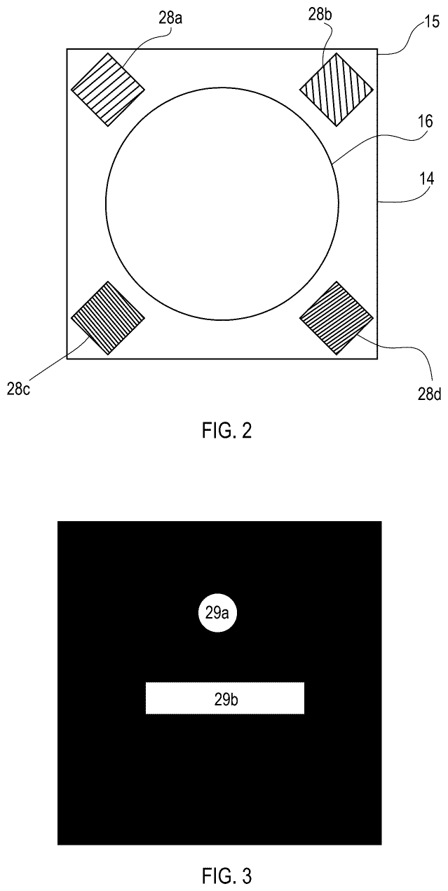

For purposes of illustration, one of alignment holograms 28 is shown in FIG. 1A, but preferably multiple alignment holograms 28 are provided. For example, multiple alignment holograms 28 and CGH 16 are shown in FIG. 2 along a substrate 14, where four alignment holograms 28 depicted are labeled 28a, 28b, 28c and 28d, located in the area of substrate 14 between the CGH 16 and its outer edge 15. Alignment holograms 28 may be located along substrate 14 differently than shown where each is a structure of etched or written lines formed at different locations along substrate 14, and the particular lines shown in FIG. 2 for alignment holograms 28 are illustrative. Less preferably, each of the alignment holograms 28 are formed on another substate and fixed in position coplanar with a substrate providing CGH 16 to provide substrate 14. While not shown, substrate 14 is fixed in a stand at a distance from interferometer 12 such that the entire cross-section (waist) of object beam 20 extends along at least the portion of substrate 14 having alignment holograms 28 and CGH 16. Each alignment hologram 28 may be formed in the same manner as CGH 16 are produced, but with the desired point or line focus engineered into the alignment hologram's structure so that the focus will form at a designed particular point or linear segment upon the reflective surface 23 when alignment target 24 is disposed at the target position for optimal CGH 16 measurement of UUT 18. For example, the target position is aligned for UUT 18 when a point focus is formed by one of alignment holograms 28 is at a point along alignment target 24 normal to curvature of curved reflective surface 23, while the target position is aligned for UUT 18 when a line focus is formed by one of alignment holograms 28 along a linear segment of alignment target 24 that matches at least substantially the curvature of curved reflective surface 23.

Any misalignment of the alignment target 24 from the target position by the point or line focus provided by alignment hologram(s) 28 being mispositioned upon curved reflective surface 23 of alignment target 24 is detectable in the interferogram outputted on display 31, as will be described below. Thus, the alignment target 24 and UUT 18 move together in fixture 27 relative to substrate 14 toward the target position until the interferogram on display 31 indicates that such point focus or line focus provided by alignment hologram(s) 28 are aligned on the curved reflective surface 23 of the alignment target 24, thereby also aligning the UUT 18 at the target position for CGH 16 for UUT 18 measurement.

The platform 26 and fixture 27 may be provided by the frame and movable carriage, respectively, as described in U.S. Pat. No. 11,774,236, issued Oct. 3, 2023, in which retroreflector is replaced by alignment target 24, and holographic regions described in the Patent are provided by alignment holograms 28. Accordingly, U.S. Pat. No. 11,774,236 is incorporated herein by reference, as well as related U.S. Patent Application Publication No. 2021/0361159, published Nov. 25, 2021 is incorporated herein by reference. However other ones of platform 26 or stands with stages allowing moving in a plurality of dimensions to micrometer accuracy may be similarly used. As such, the fixture 27 and platform 26 may be different than shown in FIGS. 1A and 1B.

Referring to FIGS. 4A, 4B, 4C, 4D, 4E, 4F, 4G, and 4H, the process of using one of the alignment holograms 28, labelled 28e, forming a single point focus on reflective surface 23 of alignment target 24 is described for alignment in system 10. Alignment hologram 28e forms a beam to a point focus 32 as illustrated in FIG. 4A. When aligned, as shown in FIG. 4B, the wavefront transmitted 20b and wavefront reflected in return beam 22a match so that point focus 32 along a virtual optical axis 33 lies normal (perpendicular) to the curved reflective surface 23. Such alignment is indicated in interferogram 34 of FIG. 4C being null, i.e., without fringes. However, when misaligned, as shown for example in FIG. 4D, such as being horizontally shifted from being parallel to the x or y axis of substrate 14, the wavefront reflected is shifted in the return beam 22a along a virtual optical axis 33a which is not normal to curved reflective surface 23, as indicated in interferogram 34 of FIG. 4E by a partial displacement 35a with respect to the interferometer's reference beam such that the entire outer profile shape of the alignment hologram is not viewed in the interferogram. In this example, such partial displacement 35a in the profile shape of the alignment hologram is along the left side thereof, indicative of horizontal displacement along the x axis in one direction with respect to substrate 14. However, if displacement 35a were along the right side of the interferogram 34 the horizontal shift along the x axis in the opposite direction. Similarly, displacement 35a at the top or bottom of the interferogram, such is indicated of either position or negative vertical shift along the y axis of alignment target 24 with respect to substrate 14. When displacement 35a is present in any of the corners of the interferogram, then alignment target 24 is tilted, where particular corner relates to the direction of shift in tilt of the alignment target 24 respect to substrate 14. The displacement 35a position in the interferogram at different degrees from right, left, up, down, and corners, can indicate a misalignment shift in more than one of horizontal, vertical, or tilt. Thus, a user (operator or technician) moves fixture 27 with respect to platform 26 to obtain an aligned condition shown in FIG. 4B indicated by interferogram 34 being null as shown in FIG. 4C. If interferogram 34 further includes, or has instead has circular fringes 35b of FIG. 4H, the distance along z axis from substrate 14 is mispositioned from alignment with CGH 16, such that point focus 32 fails to focus on reflective surface 23 by being too close as illustrated in FIG. 4F, or too far as illustrated in FIG. 4G, from reflective surface 23, and the alignment target 24, in fixture 27 is moved until such circular fringes disappear to obtain the null interferogram 34 shown in FIG. 4C.

While a single alignment holograms 28e is useful, adding additional alignment holograms 28 increases alignment sensitivity, as indicated by additional alignment holograms 28g, 28f, 28h, and 28i (28e-i) in FIG. 5, each additional alignment hologram providing a tilted one of virtual optical axis 33 that will lie normal to reflective surface 23 for their respective point focus 32 at spaced points along reflective surface 23. By alignment holograms 28e-i being at different locations along substrate 14, they will each will appear at a different portion in interferogram 34, and similarly aligned per the discussion above for alignment hologram 28e to alignment target 24. The number, spacing from each other, and location of each of the alignment holograms 28e-i along substrate 14 may be different than illustrated in FIG. 5.

Referring to FIG. 6A and 6B, an example of alignment hologram 28 labeled 281 is shown providing a central diffractive portion 28l1 providing a point focus, same as provided by alignment hologram 28e, and an outer diffractive portion, about the periphery of central portion 28l1, providing an annular focus 28l2 that sends light rays a virtual optical axis 33b all normal along to the curved reflective surface 23 of alignment target 24. The annular portion 28l2 rays may be deemed confocal with each other. The rays along virtual optical axis 33b are more sensitive to alignment compared to the rays coming to focus at a point focus 32 on reflective surface 23 from central region 2811 aligned along virtual optical axis 33. The absence of fringes indicative of alignment is shown in the FIG. 6C interferogram 34, and an example of misalignment is shown in FIG. 6D interferogram 34 having partial displacement 35a associated with alignment hologram 28l1 showing lateral misalignment along x and/or y axes, and fringes 35c associated with alignment hologram 2812 showing off-center misalignment, between substrate 14 and alignment target 24 from the desired target position. If circular fringes 35b were seen in the central circular portion of interferogram, associated with alignment hologram 28l1, then like in FIG. 4H, such would indicate misalignment in distance between substrate 14 and alignment target 24 from the desired target position. Such pattern combination provided by alignment hologram 28l may improve the sensitivity of alignment compared to the point focus pattern alone.

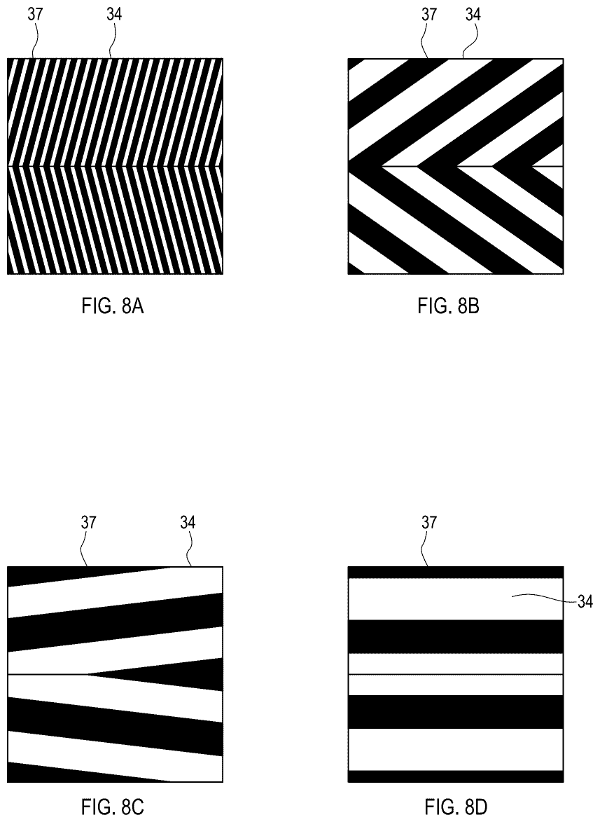

Referring to FIGS. 7A, 7B, 8A, 8B, 8C, and 8D, the process of using one of the alignment holograms 28, labelled 28j, forming a line focus on reflective surface 23 of alignment target 24 is described for alignment in system 10. Alignment hologram 28j forms a toroidal or arc shaped curved wavefront in object beam 20b creating a line focus when matching the curvature along a desired linear segment of the reflective surface 23, lying normal thereto at any point along the curvature, when alignment target 24 is aligned in system 10. FIG. 7A shows the line focus 36 from alignment hologram 28j in alignment along reflective surface 23 of alignment target 24 along the y-z axes, while FIG. 7B shows the same line focus 36 but along the x-z axes, such that in FIG. 7A curved line extends into the page of the paper along the curvature of reflective surface 23. Line focus 36 is sensitive for alignment in only one dimension along the direction of the line formed along the reflective surface 23. Thus, preferable multiple ones of alignment holograms 28 are provided in substrate 14 each sensitive for alignment in a different dimension along the direction of the line focus 36 forms along the reflective surface 23, such as vertical, horizontal, and angle (tilted) lines. Misalignment of line focus 36 is detectable by non-parallel fringes 37 in interferograms 34 as shown in FIG. 8A. As the alignment target 24 along fixture 27 is moved toward alignment to a target position for CGH 18, the fringes 37 in interferogram 34 changes as shown in FIGS. 8B and 8C until the fringes 37 become at least substantially parallel to each other as shown in the interferogram 34 of FIG. 8D indicating the alignment condition illustrated in FIGS. 7A and 7B.

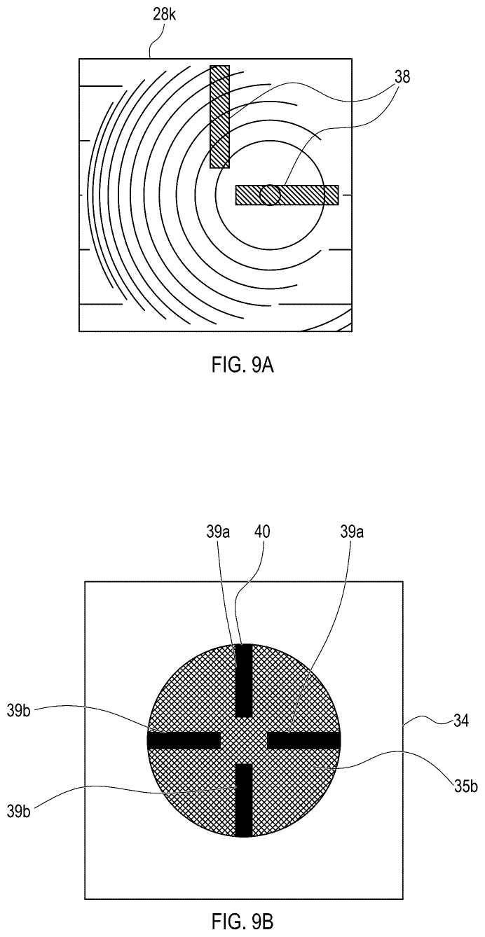

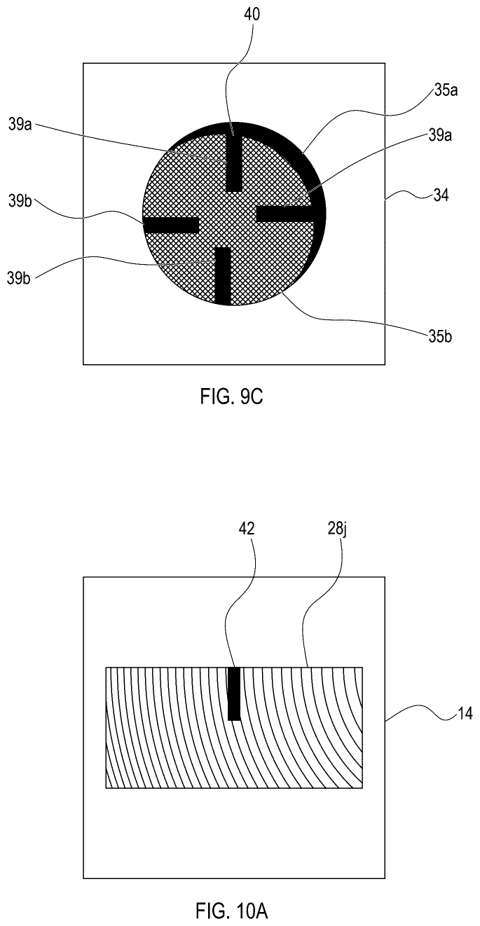

Optionally, opaque patterns may be added upon the structure about, or slightly offset from the center, of one or more of the alignment holograms 28 to aid in alignment in system 10. FIG. 9A shows two orthogonally disposed opaque linear markings (segments or regions) 38, along x and y axes, providing a shadow pattern for one of alignment hologram 28 denoted as 28k that provides a point focus, as in the case of alignment hologram 28e of FIG. 4A. Markings 38 along the alignment hologram 28e are spaced from the center of the spherical wavefront and at right angles to each other. Markings 38 may be formed by placing a mask over the front or back surface of alignment hologram aligned with the center thereof, depositing light blocking material in openings of the mask aligned for regions 18, such material may be chrome or other metallization, and then removing the mask leaving the desired configuration of markings 38.

In the return beam 22b, the markings 38 are mirrored, rotated 180 degrees and inverted, so that the interferogram 34 of FIG. 9B has a first set of two regions 39a corresponding to the original two markings 38 and a second set of two regions 39b representing the mirrored original patterns rotated 180 degrees from the first set of two regions 39a. When the two regions 39a and 39b align at least substantially 180 degrees with each other providing a cross-hair 40 representation, then virtual optical axis 33 of the point focus 32 is aligned normal to the curvature of reflective surface 23. If not so aligned as shown for example in the FIG. 9C interferogram 34, then alignment target 24 is mispositioned laterally along x and/or y axes, and is moved until such cross-hair 40 representation is at least substantially established in the interferogram 34. While the FIG. 9B shadow regions 39a and 39b show alignment in x and y axes between substrate 14 and alignment target 24, lateral misalignment along x and/or y axes as indicated in FIG. 9C interferogram 34 would further be found by displacement 35a in the interferogram, and/or circular fringes 35b (FIG. 4H) showing distance misalignment along the z axis of a point focus 32 as discussed earlier.

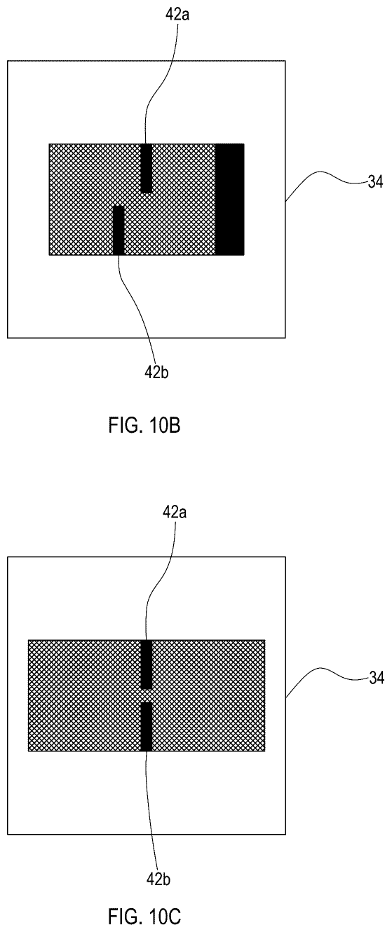

An opaque pattern may similarly be added to the alignment holograms 28 providing a line focus, such as alignment hologram 28j of FIG. 9A as shown in FIG. 10A by adding a single linear opaque marking (segment or region) 42 spaced about the center of the structure of alignment hologram 28j, such as along one of the x or y axes. In the return beam 22b, the shadow pattern is mirrored, rotated 180 degrees and inverted, as shown in the interferogram 34 of FIGS. 10B and 10C, where a first region 42a corresponds to original single linear region 42 upon the structure of the alignment hologram 28j, and a second single linear region 42b represents the mirrored original pattern of marking 42 rotated 180 degrees and inverted from region 42a. When line focus for alignment hologram 28j is misaligned along reflective surface 23, then regions 42a and 42b will be offset from each other as shown in FIG. 10B and alignment target 24 is thus mispositioned and moved until regions 42a and 42 align along the same dimension, as a cross-hair 41 along a single dimension about a center of interferogram 34 as shown in FIG. 10C with regions 42a and 42b align at least substantially 180 degrees with each other.

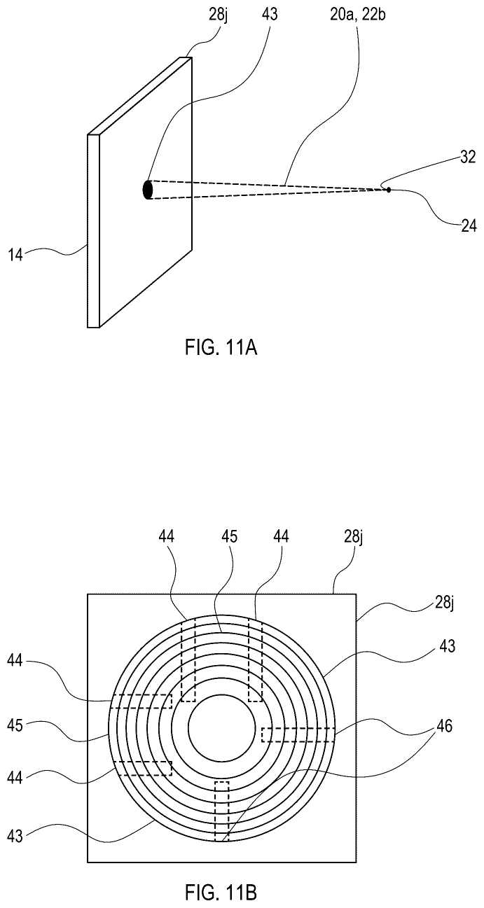

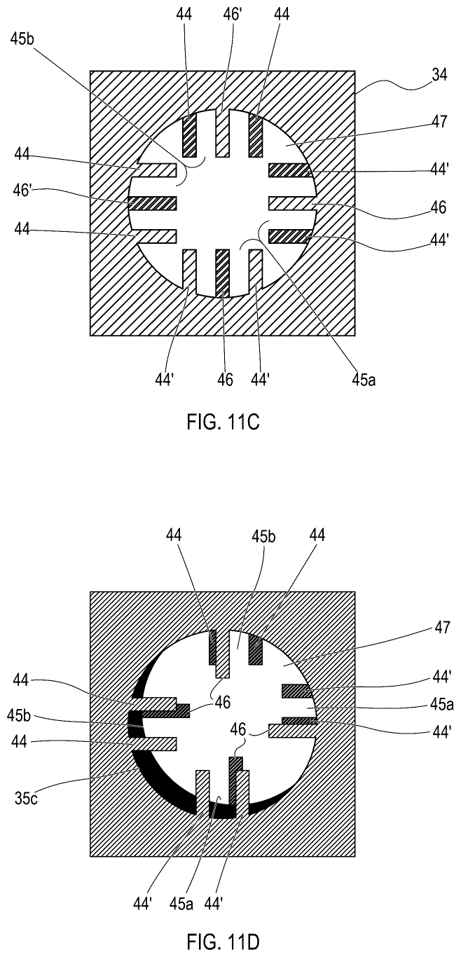

Referring to FIGS. 11A, 11B, 11C, and 11D, another opaque pattern may be added to one of the alignment holograms 28 providing a point focus, such as alignment hologram 28e of FIG. 4A, to provide an alignment hologram denoted as 28j. As shown in FIG. 11B, in a central circular area 43 along alignment hologram 28j, two pairs of opaque parallel linear markings (segments or regions) 44 each with a gap 45 there between are provided, where the two pairs are at right angle to each other about center of the structure of alignment hologram 28j, and two opaque linear markings (segments or regions) 46 at right angle about the center of such structure are each disposed facing the gap 45 of different one of along pairs of opaque linear markings 44. In return beam 22b, regions 44 and region 46 are rotated 180 degrees and inverted to provide mirrored markings 44′ and a marking 46′ the interferogram 34 of FIG. 11C in which each of the original single marking 46 aligns in gap 45a of a rotated one of pairs of mirrored markings 44′, and each rotated single mirrored marking 46′ aligns in the gap 45b of a different one of original pairs of opaque linear markings 44. Where the interferogram 34 of FIG. 11C shows an alignment condition of the point focus of alignment hologram 28j on reflective surface 23 of alignment target 24 with triple cross-hair 47, instead of the single cross-hair 40 of FIG. 9B, providing a lock and key alignment where if region 46 does not lie in gaps 45 between paired regions 44 there is misalignment such as shown for example in FIG. 11D, in addition to misalignment being indicative by any displacement 35a (FIG. 4E) in the aperture of the alignment hologram or circular fringes 35b (FIG. 4H) in the interferogram 34.

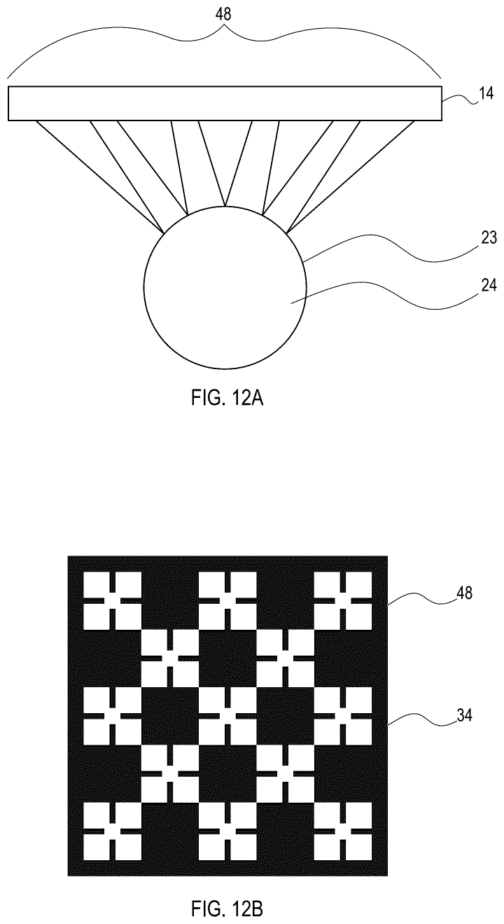

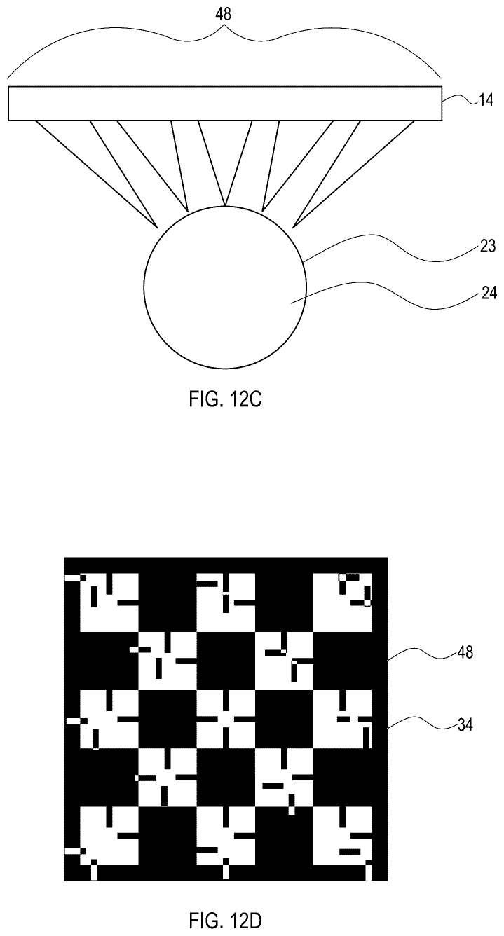

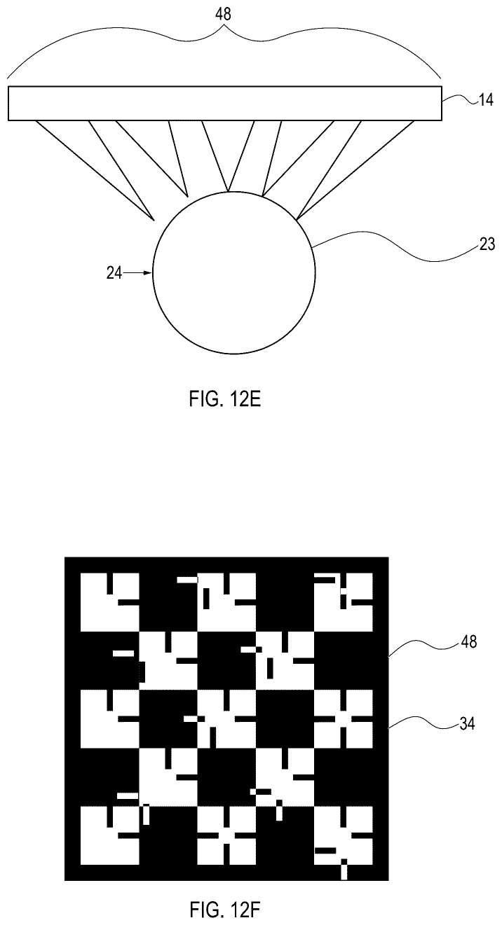

Referring to FIGS. 12A, 12B, 12C, 12D, 12E, and 12F, alignment of two-dimensional array 48 of twenty-five (25) alignment holograms 28 is shown each providing a different point focus along reflective surface 23 of alignment target 24, where the structure of each alignment hologram in the array has shadow pattern provide by opaque linear markings 38 of FIG. 9A. Each row of diffractive structures of array 48 may be provided by a set of diffractive structures 28e-28i (FIG. 5), where adjacent rows are equally spaced from each other in positioning point foci along different spaced points upon reflective surface 23. FIG. 12A shows array 48 of point foci 32 from alignment holograms 28 aligned on alignment target 24, and FIG. 12B shows the resulting interferogram 34 with each of the cross-hairs 40 (FIG. 9B) aligned from each alignment hologram in array 48. FIGS. 12C and 12E shows array 48 of point foci 32 from alignment holograms 28 for two conditions of misaligned on alignment target 24. FIG. 12D show the resulting interferogram 34 from the misalignment of FIG. 12C in which only the centermost cross-hair 40 (FIG. 9B) in the returned beam 22b is aligned, and cross-hairs 40 of all other alignment holograms are misaligned. FIG. 12F show the resulting interferogram 34 from the misalignment of FIG. 12E in which two cross-hair 40 (FIG. 9B) in the returned beam 22b is aligned for two alignment holograms 28, and cross-hairs 40 of all other alignment holograms 28 are misaligned. In this manner, array 48 provides sensitivity to misalignment of the alignment target 24 along multiple dimensions.

While opaque linear markings 38, 42, 44, or 46 are preferred other opaque linear markings may be provided about the center of alignment hologram 28, such as a one or more circular marking(s) about such center, or other marking geometry. Also, markings 38, 42, 44, or 46 may instead be phase shifting regions representing a surface relief provided in the transparent material, such as glass, of one of alignment hologram 28 to create mirrored patterns of such phase shifting regions, rather than being opaque for blocking light, and similarly provide interferograms 34 as shown in FIGS. 9B, 9C, 10B, 10C, 11C, 11D, and 12B, 12D, and 12F.

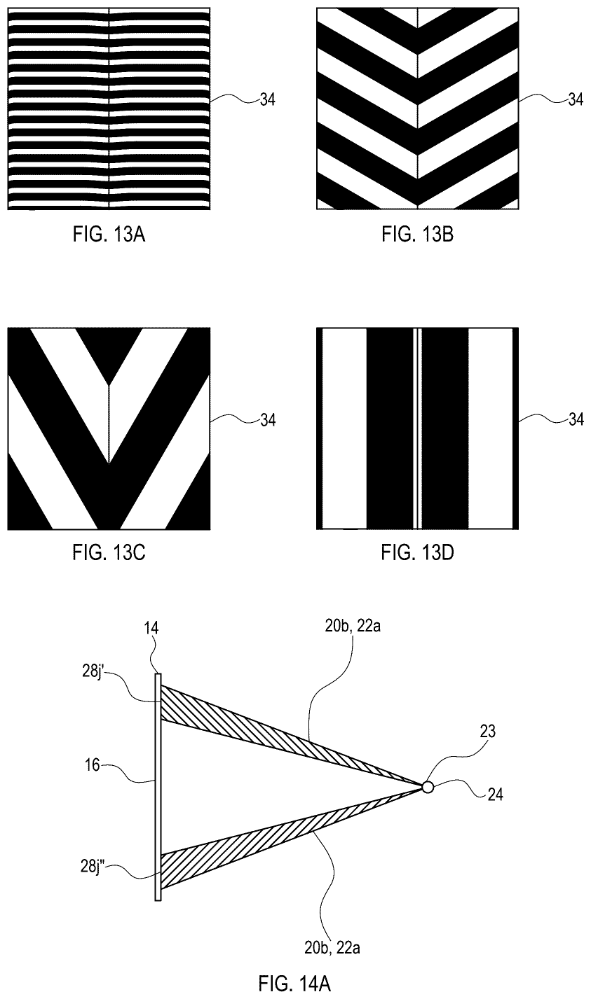

It has been found that the sensitivity of alignment of ones of alignment holograms 28 providing a line focus, such as shown in FIGS. 7A for alignment hologram 28j has improved sensitivity in interferograms in providing parallel fringes 37 indicating alignment of alignment target 24 when the line focus formed is slightly tilted from a normal virtual optical axis with the curvature of reflective surface 23 to provide an orthogonal tilted wavefront as shown in the interferograms 34 of FIGS. 13A, 13B, 13C, and 13D. Misalignment being detectable by non-parallel fringes 37 in interferograms 34 as shown in FIG. 13A. As the alignment target 24 along fixture 27 is moved toward alignment to a target position for CGH 18, the fringes 37 in interferogram 34 changes as shown in FIGS. 13B and 13C until the fringes 37 become at least substantially parallel to each other as shown in the interferogram 34 of FIG. 13D indicating the alignment condition illustrated in FIGS. 7A and 7B, in which the orthogonal tilted wavefront is so slight it is detectable by the interferometer 12, but not visually perceptible to the human eye in FIGS. 7A or 7B.

Structural changes may be made to one or more of the alignment holograms 28 to provide an overlayed wavefront of odd symmetry or tilt carrier modulation along reflective surface 23 of alignment target 24 in addition to forming the point focus or line focus described earlier. This modulation, like opaque patterns described earlier, rotate 180 degrees, in the return beam 22 reflected from alignment target 24 which will null the modulation when alignment target 24 is at the target position, but if the alignment target 24 is offset from the desired target position a detectable signature will form in the interferogram indicating misalignment. By selection of wavefront modulation function overlayed upon one of alignment holograms 28, orthogonal (unique) wavefront signatures connected to specific misalignment degrees of freedom (such as along x, y, and/or z axes or tilt) are viewable in interferogram 34 for assisting the user in moving alignment target 28 upon fixture 14 to the target position for CGH 16.

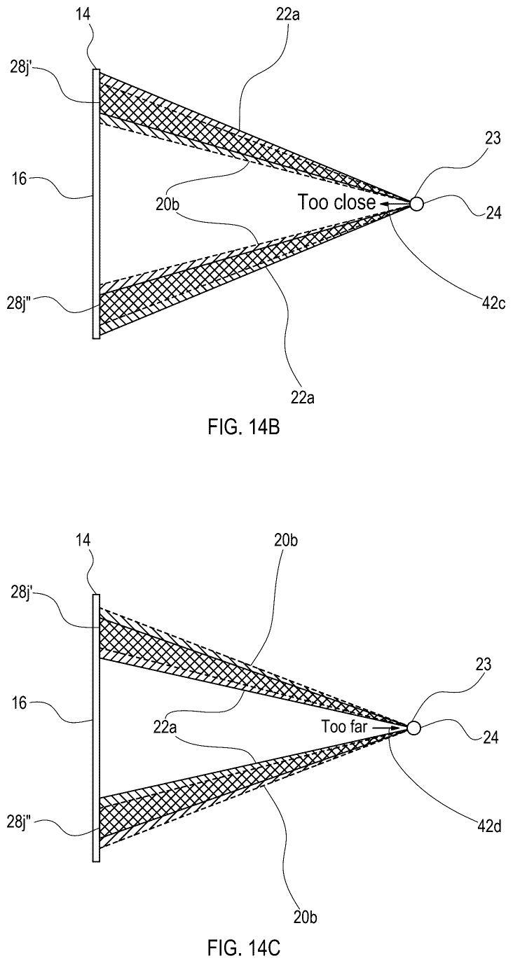

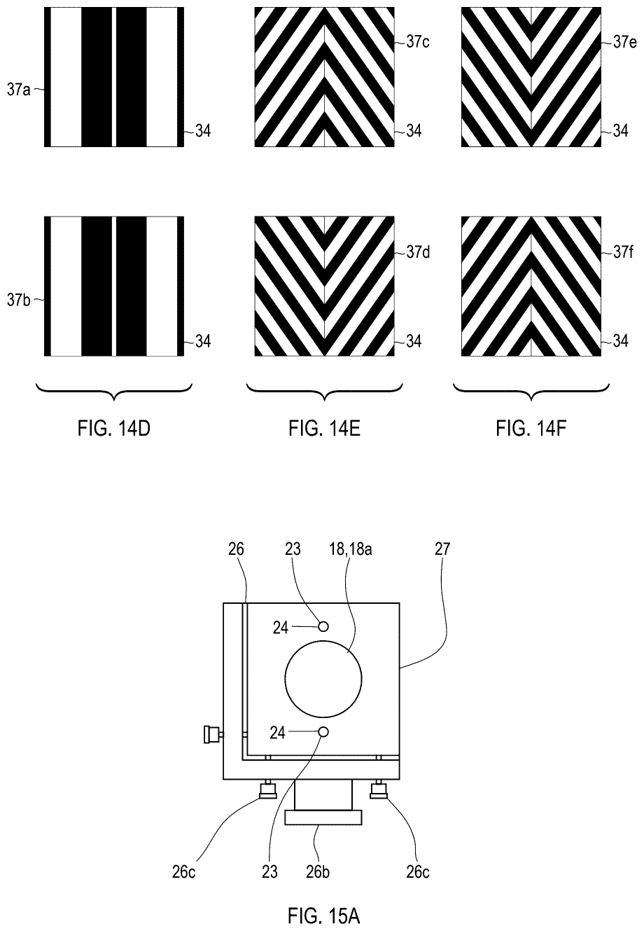

Referring to FIGS. 14A, 14B, 14C, 14D, 14E and 14F, an example of alignment in system 10 is shown for an example of substrate 14 with two alignment holograms 28j′ and 28j″, vertically disposed along edge 15 near the top and bottom of substrate 14 with CGH 16, each forming a wavefront of a line focus 36 along a different linear segment along curved reflective surface 23 of alignment target 24. For purpose of illustration, the portion of object beam 20a and return beam 22 with respect to UUT 18 are not shown in the figures of this example. As shown in FIG. 14A, the two line foci 36 from the alignment holograms 28j′ and 28j″ are indicated as being in alignment along curved reflective surface 23 providing generally parallel fringes 37a and 37b, respectively, on interferogram 34 of FIG. 14D. If the alignment target 24 is too close (as denoted by arrow 42b) in distance to substrate 14 as shown in FIG. 14B such results in the interferogram 34 of FIG. 14E having fringes 37c which point upwards for alignment hologram 28j′ and fringes 37d which point downwards for alignment hologram 28j″ such that fringes 37c and 37c point away from each other. If however the alignment target 24 is too far (as denoted by arrow 42a) in distance to substrate 14 as shown in FIG. 14C results in the interferogram 34 of FIG. 14F having fringes 37e which point downwards for alignment hologram 28j′ and fringes 37f which point upwards for alignment hologram 28j″ such that fringes 37c and 37c point towards from each other.

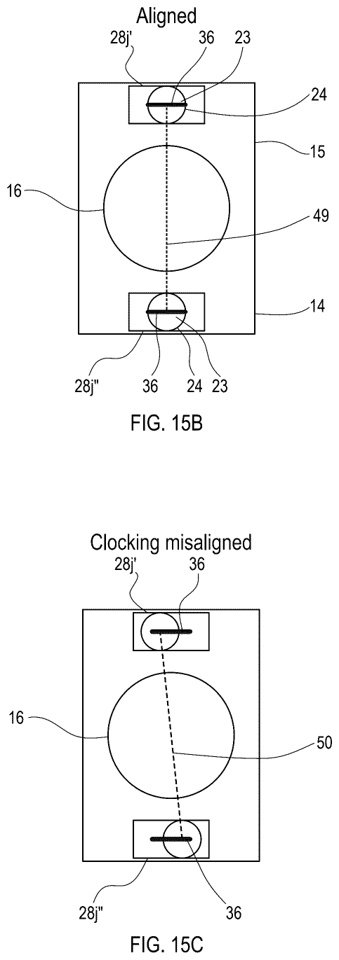

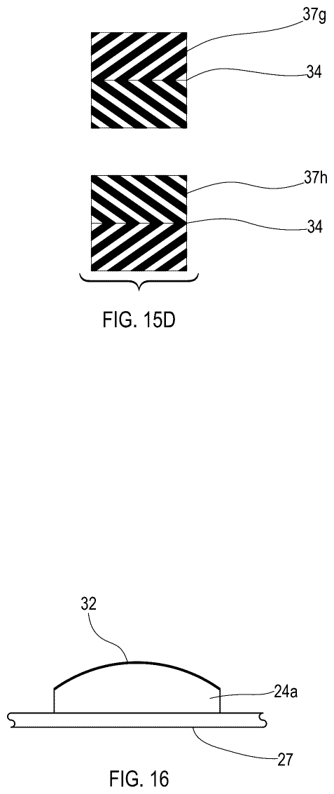

Referring to FIG. 15A, another embodiment of fixture 27 movable with respect to platform 26 is shown having two different ones of alignment targets 24 mounted to fixture 27, one above and the other below the UUT 18 to be measured for use with substrate 14 having alignment holograms 28j′ and 28j″ which now provide alignment using two alignment targets 24 rather than a single alignment target 24 are mounted to fixture 27. FIG. 15B is a depiction of a view through alignment holograms 28j′ and 28j″ of alignment of their line foci 36 upon alignment targets 24 of FIG. 15A. Depending the viewer orientation with respect to substrate 14, the line foci 36 will appear as horizontal or vertical along the curvature of alignment target 24 when viewed through alignment holograms 28j′ and 28j″. In FIG. 15B, line foci 36 are illustrated as aligned vertically along a vertical dimension 49 parallel to vertical axis y of substrate 14 and to each other when each are aligned along their respective alignment target 24. FIG. 15C is the same view as FIG. 15B, except where the two different ones of alignment targets 24 are illustrated as clocked (slightly rotated) along a dimension 50 from vertical axis of substrate 14 and thus misaligned upon the curved reflective surface 23 of their respective alignment target 24. Such results in interferogram 34 of FIG. 15D having fringes 37g which point left for alignment hologram 28j′ and fringes 37h which point right for alignment hologram 28j″. Similarly, if the slant of dimension 50 was in the opposite direction to that shown in FIG. 15B, then fringes 37g would point right and fringes 37h would point left. The direction of clock of the fringes thus assists the user in determining direction to move fixture 27 to correct such misalignment with respect to substrate 14 until interferogram 34 of substantially parallel lines for each alignment hologram is detected (as shown for example in FIG. 14D). While only two alignment holograms 28j′ and 28j″ are illustrated, other alignment holograms 28 with or without opaque marking(s) or phase shifting region(s) may be provided on substrate 14 for use in alignment.

While the alignment target 24 is shown as a spherical mirror ball, such as a tooling ball, providing the curved convex reflective surface 23, any curved convex or concave symmetric or aspheric reflective surface may provide specular reflective surface 23 of alignment target 24, so long as alignment holograms 28 provide alignment hologram(s) each form a wavefront that matches one of a point focus normal at a point along the curvature of such reflective surface, or a line focus along a target curved segment along curved reflective surface 23, when the UUT 18 to be measured is a target position aligned for interferometric measurement via the CGH 16 with or without with or without use of opaque marking(s) or phase shifting region(s). Other embodiments of alignment target 24 are shown in FIGS. 16, 17, 18A, 18B, and 19 for alignment targets 24a, 24b, and 24c.

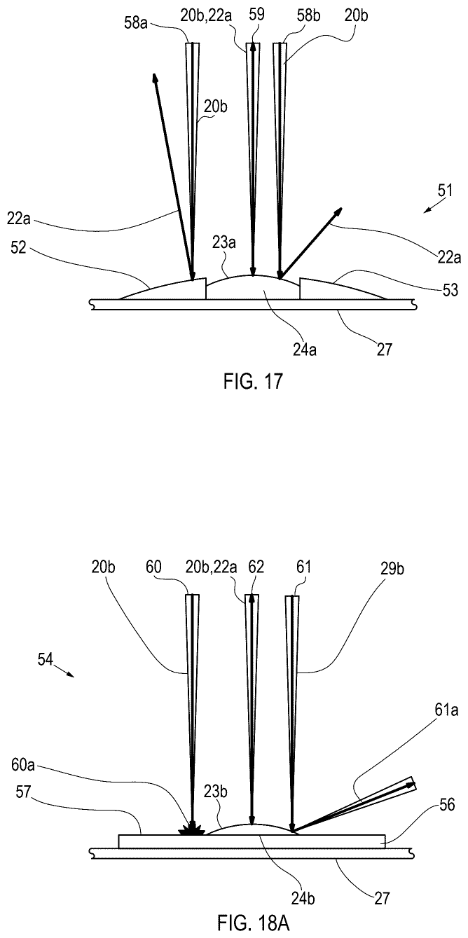

In FIG. 16, alignment target 24a is shown having a circularly symmetric curved reflective surface 23a mounted to fixture 27. FIG. 17 shows an assembly 51 of the same alignment target 24a of FIG. 16 providing a central alignment target 24a with a reflective curved surface 23a surrounded by an alignment target 52 with a concentric specular reflective curved reflective surface 53 of a different curvature than that the reflective surface 23a of the central alignment target 24a, to provide a large dynamic range of alignment, in this case coarse and fine interferometric alignment. Optionally, reflective curved surface 23a and 53 may be considered two portions or surfaces of the same alignment target. Assembly 51 provides an outer annular region along reflective surface 53 of alignment target 52 which is a less steeply curved surface than the curvature of the inner region provided by circularly symmetric curved reflective surface 23a of alignment target 24a. The less steeply curved reflective surface 53 enables a less tilted reflection beam per amount of misalignment, and can be used for coarse alignment in interferogram 34 in system 10. The more steeply curved reflective surface 23a enables a more tilted reflection beam per amount of misalignment, and can be used for fine alignment in interferogram 34 in system 10. Thus, if fixture 27 with assembly 51 mounted thereto is positioned with respect to substrate 14 such that the object beam 20b through alignment hologram is misaligned by the return beam 22a as indicated by point/line focus 58a reflecting along curved reflective surface 53 such provides coarse alignment in interferogram 34. While a point/line focus 58b reflecting from curved reflective surface 23a of alignment target 24a provides finer alignment in interferograms 34 until alignment is detected in interferogram 34 by point/line focus 59 centered or near center along alignment target 24a. Interferogram 34 being utilized as described earlier to assist the user in moving fixture 27 toward alignment in system 10 to obtain aligned point/line focus 59.

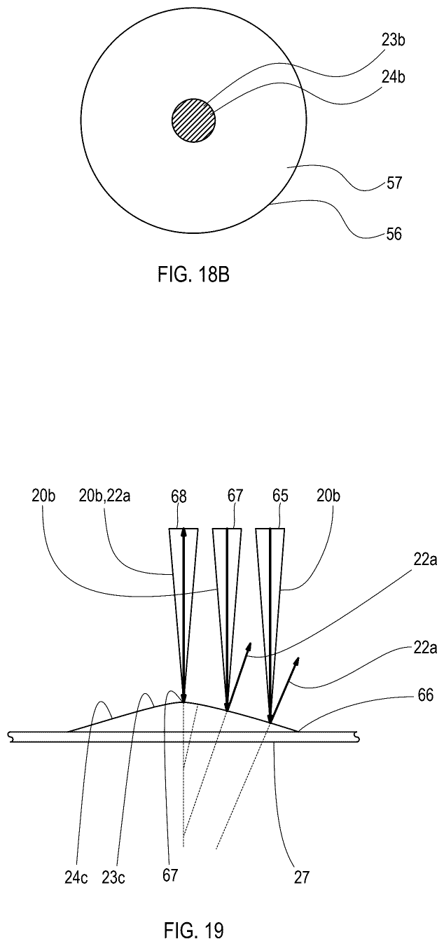

In another example of FIGS. 18A and 18B, visual coarse visual alignment is provided with fine interferometric alignment using alignment target 24b. An assembly 54 is provided having alignment target 24b with a circularly symmetric curved reflective surface 23b mounted centered upon a circular shaped substrate 56 having a diffuse reflective surface 57, such as rough reflective flat mirror or other light diffusing material. The diffuse reflective surface 57 displays a point/line focus from one of alignment holograms 28 visually to a user when incident thereto, while the center alignment target 24b operates in the same manner as alignment target 24 for alignment using interferograms 34 as described earlier. Thus, if fixture 27 with assembly 54 mounted thereto is positioned with respect to substrate 14 such that the object beam 20b through alignment hologram is misaligned by the return beam 22a such is indicated either by point/line focus 60 reflecting along diffuse reflective surface 57 causing visible specular reflection 60a (rather than return beam 22a), or by point/line focus 61 reflecting partially along diffuse reflective surface 57 causing a specular reflected beam 61a. Reflection 60a or specular reflected beam 61a will be visually perceivable to the user viewing fixture 27, thereby providing notice of such misalignment and to move fixture 27 until no reflection 60a or specular reflected beam 61a is viewed, such that point/line focus is upon curved reflective surface 23b whether or not yet in alignment thereupon. Interferogram 34 is then utilized as described earlier to assist the user in moving fixture 27 toward alignment in system 10 to obtain aligned point/line focus 62.

In a further example, FIG. 19 shows an alignment target 24c that provides large dynamic range of alignment, in this case the curvature of a curved reflective surface 23c gradually increases in curvature from the outer diameter edge 66 to the center 67 of the alignment target, providing coarser alignment near the outside, and finer alignment near the center. Thus, if the object beam 20b through alignment hologram 28 is misaligned in the return beam 22a by the point/line focus 65 being incident curved reflective surface 23c closer to the outer edge 66 of alignment target 24c, such provides coarse alignment in interferogram 34. The alignment target 24c is moved by the user such that object beam 20b moves away from outer edge 66 closer to center 67 of alignment target 24c, such as indicated by point/line focus 67, and less coarse alignment in interferogram 34 is provided, until alignment is achieved as indicated by point/line focus 68 at or near center 67 of alignment target 24c.

While a single point/line focus being centrally aligned is shown in FIGS. 17, 18A, and 19, multiple ones of such point/line foci may be provided depending on the particular alignment holograms 28 on substrate 14 and each may align along different locations/line segments upon the respective alignment target 24a, 24b, or 24c. Thus, alignment targets 24a, 24b, and 24c, or their respective assemblies shown in FIGS. 17, 18A, 18B, and 19 with such alignment targets may be mounted to fixture 27, and used in system 10 for alignment of UUT 18 for interferometric measurement by CGH 18.

The figures showing interferograms 34 outputted on display 31 by interferometer 12 of FIG. 1A represent the interferogram of interest in the particular discussion of alignment and misalignment using alignment hologram(s) 28. In operation, the interferogram 34 would also display the results of interference of the interferometer's reference beam from returned beams 22 and 22a from CGH 16 and each alignment hologram 28, respectively. The user, operator, or technician performing system 10 alignment by absence of any displacement 35a in the aperture of alignment hologram 28 or circular fringes 35b in the case of a point focus, by detecting the level of parallel linear fringes 37 for a line focus, and/or detect the alignment of cross-hairs 40, 41, or 47 in the case of optional opaque marking(s) or phase shifting regions region(s), in portions of the interferogram 34 related to same to determine whether alignment target 24 is in an aligned or misalignment, and if misalignment moving the alignment target 24 accordingly to an aligned state, indicating alignment of UUT 18 in fixture 27 with CGH 16 at the optimal target position for interferometric measuring the spatial profile of UUT's surface 18a.

As stated earlier, while interferometer 12 may be a Fizeau interferometer, interferometer 12 may be instead provided by other equipment, such as a wavefront sensor, operable for viewing wavefronts of beams on display 31 using computer system 30 which are reflected from the curved reflective surfaces of the alignment targets 24, 24a, 24b, and 24c, or reflective surface 52 in the case of assembly 51. Further, while preferably one or more alignment holograms 28 provide point or line focus are utilized, optionally alignment in system 10 may be solely by relying on opaque or phase-shifted pattern created by marking(s) or region(s) along one or more areas upon the surface of substate 14 such that moving alignment target 24, 24a, 24b, and 24c obtains desired symmetry of cross-hairs 40, 41, or 47 about a center on display 31 thereby indicating alignment of UUT 18 to the CGH 16. While system 10 preferably has CGH 16 for measuring UUT 18, alignment hologram(s) 28 in system 10 may optionally be used without providing any measurement CGH or UUT, such as in the case of utilizing interferometer 12 or wavefront sensor in order to fine tune orientation and/or distance with respect to alignment target(s) 24, 24a, 24b, and 24c along a fixture or other structure at a desired target position from the substrate 14 with such alignment hologram(s) 28.

From the foregoing description, it will be apparent that a system and method for interferometric measurement alignment has been provided useful in aligning a CGH for UUT spatial profile measurement. Variations and modifications of the herein described system and method will undoubtedly suggest themselves to those skilled in the art. Accordingly, the foregoing description should be taken as illustrative and not in a limiting sense.

1. A system for interferometric measurement alignment comprising:
an interferometer outputting an object beam, receiving a return beam, and outputting on a display an interferogram representative of any phase interference of said return beam with a reference beam;
at least one alignment target having a reflective surface with curvature representing a target surface; and
one or more alignment holograms disposed at a first position, each of said one or more alignment holograms transforms at least a portion of said object beam into an alignment wavefront which will form a point or line focus along said curvature of said target surface of said alignment target when said alignment target is disposed at a target position with respect to said first position, and said alignment target being movable to correct any misplacement of said alignment target from said target position until said interferogram indicates said alignment target is disposed at said target position by said point focus or line focus being formed along said curvature of said target surface.

2. The system according to claim 1 wherein said interferogram indicates said alignment target is disposed at a target position by said line focus being formed along said curvature of said target surface by said interferogram having at least substantially parallel fringes.

3. The system according to claim 1 wherein said interferogram indicates said alignment target is disposed at a target position by said point focus being formed along said curvature of said target surface by said interferogram having an absence of said any fringes, and an aperture of the alignment hologram being entirely in view in said interferogram without displacement.

4. The system according to claim 1 further comprising:
a substrate having said one or more alignment holograms and a measurement computer-generated hologram (CGH) providing a measurement wavefront representative of a target spatial profile for a unit under test (UUT); and
a fixture supporting said UUT, and said alignment target being disposed on said fixture in which movement of said fixture enables said alignment target and said UUT to be movable together.

5. The system according to claim 4 wherein when said alignment target is positioned at said target position, said measurement CGH transforms said object beam into said measurement wavefront which falls upon said UUT, and said return beam reflected by said UUT travels, via said measurement CGH, to said interferometer in which said interferometer outputs said interferogram on said display representative of any departure of a surface of said UUT from said target spatial profile, thereby enabling interferometric measuring of the surface of said UUT.

6. The system according to claim 4 wherein said substrate extends along x and y axes orthogonal dimensions, and along a z axis orthogonal to said x and y axes, and said fixture is movable at least along said x, y, and z axes with respect to said substrate until said alignment target is positioned at said target position.

7. The system according to claim 6 wherein said target position is parallel to said x and y axes of said substrate, and any misalignment of said alignment target from said target position is along one or more of said x, y, or z axes, or tilt along one of planes extending along one or more of said x and y axes, x and z axes, or, y and z axes.

8. The system according to claim 4 further comprising a platform, said fixture is movable with respect to a platform utilizing a plurality of controls each providing a different degree of freedom of motion to said fixture to correct any misalignment of said alignment target from said target position.

9. The system according to claim 1 wherein said curvature of said reflective surface along said alignment target representing said target surface is one of spherical, convex, concave, aspheric, or freeform.

10. The system according to claim 1 further comprising a plurality of different ones of said alignment target each have said reflective surface with same or different one of said target surface in accordance with a different one of said one or more alignment holograms.

11. The system according to claim 1 wherein a plurality of said alignment holograms each transforms at least a portion of said object beam into an alignment wavefront which will form a different point or line focus along a different position along said target surface of said alignment target when said alignment target is disposed at a target position.

12. The system according to claim 1 wherein at least one of said one or more alignment holograms transforms at least a portion of said object beam into an alignment wavefront having a central portion providing a point focus, and an outer portion providing an annular focus about a periphery of said central portion, along said curvature at said target surface of said alignment target when said alignment target is disposed at said target position; and
said alignment target being movable to correct any misplacement of said alignment target from said target position by moving said alignment target until said interferogram indicates said alignment target is disposed at a target position by said point focus and said annular focus being formed along said curvature of said target surface.

13. The system according to claim 1 wherein said alignment target has a plurality of ones of reflective surface of different curvature in which one of said plurality of reflective surface represents said target surface.

14. The system according to claim 1 wherein said alignment target has a central region providing said reflective surface representing said target surface and a diffuse reflective surface extending about the periphery of said central region.

15. The system according to Claim 1 wherein at least one of said one or more alignment holograms has a structure with a center and one or more opaque markings or phase shifting regions disposed about said center providing mirrored ones of said one or more opaque markings or phase shifting regions which align with said one or more opaque markings or phase shifting regions in said interferogram on said display of said interferometer when said alignment target is disposed at said target position.

16. The system according to claim 1 wherein at least one of said one or more alignment holograms provides said point focus having a structure with a center and two linear opaque markings or phase-shifting regions disposed about said center of the alignment hologram at a right angle to each other and said interferogram indicates said alignment target is disposed at said target position by said point focus being formed along said curvature of said target surface and mirrored ones of said linear markings or regions in said return beam represent an aligned cross hair along two orthogonal dimensions in said interferogram.

17. system according to claim 1 wherein at least one of said one or more alignment holograms provides said line focus having a structure with a center and a linear opaque marking or phase-shifting region disposed about said center of the alignment hologram and said interferogram indicates said alignment target is disposed at said target position by said line focus being formed along said curvature of said target surface and mirrored ones of said linear marking or region in said return beam represent an aligned cross hair along one dimension in said interferogram.

18. The system according to claim 1 wherein at least one of said one or more alignment holograms provides said point focus having a structure with a center and two opaque linear parallel markings or phase-shifting regions disposed with a gap between them aligned about said center of the alignment hologram, and an opaque linear marking or phase-shifting region disposed about said center at a right angle with respect to said gap, and said interferogram indicates said alignment target is disposed at said target position by said point focus being formed along said curvature of said target surface and mirrored ones of said single linear marking or region in said return beam being centered in said gap about the center of the interferogram, and said linear marking or region aligned in a mirrored one of said gap between mirrored ones of said two linear markings or regions about the center of the interferogram.

19. The system according to claim 1 wherein at least one of said one or more of alignment holograms further has a phase function with a wavefront modulation of a symmetry that cancels out upon reflection from said target surface when said alignment target is disposed at said target position, and any misalignment of said alignment target from said target position forms a wavefront signature in said interferogram.

20. A system for aligning a computer-generated hologram with a unit under test (UUT) to enable spatial profile measurement of a surface of the UUT, said system comprising:
a fixture upon which is mounted an alignment target having a reflective surface with curvature, and a UUT to be measured; and
one or more alignment holograms, oriented at a position of a measurement computer-generated hologram (CGH), each characterized by forming a wavefront that matches one of a point focus normal at a point along the curvature of said reflective surface, or a line focus along a segment of the curvature of said reflective surface, when said UUT is at a position aligned for measurement via said measurement CGH.

21. The system according to claim 20 further comprising an interferometer or wavefront sensor for detecting when the wavefront from each of the one or more alignment holograms are aligned along the reflective surface of said alignment target.

22. The system according to claim 21 wherein said fixture is movably mounted with respect to a platform to reposition said alignment target with respect to the one or more alignment holograms until alignment of the wavefront of each of the one or more alignment holograms upon said alignment target is detected utilizing said interferometer or wavefront sensor.

23. The system according to claim 21 wherein at least one of said one or more alignment holograms has a structure with a center and one or more opaque markings or phase- shifting regions disposed about said center provides mirrored ones of said one or more markings or regions are symmetrically distributed about the center with said one or more markings or regions on a display of said interferometer or wavefront sensor when said at least one of said one alignment holograms is aligned along the reflective surface.

24. A method for aligning a computer-generated hologram with a unit under test (UUT) to enable spatial profile measurement of a surface of the UUT comprising steps of:
providing a fixture having an alignment target having a reflective surface with curvature, and a UUT to be measured; and
providing one or more alignment holograms, oriented at a position of a measurement computer-generated hologram (CGH), each characterized by forming a wavefront that matches one of a point focus normal at a point along the curvature of said reflective surface, or a line focus along a segment of the curvature of said reflective surface, when the UUT is at a position aligned for measurement via the measurement CGH.

25. The method according to claim 24 further comprising step of utilizing an interferometer or wavefront sensor to detect when the wavefront from each of said one or more alignment holograms are aligned along the reflective surface of said alignment target.
